(19) United States
(12) Patent Application Publication
(10) Pub. No.: US 2022/0284221 A1
(43) Pub. Date: Sep. 8, 2022

(54) DEEP LEARNING BASED PARAMETRIZABLE SURROUND VISION

(71) Applicant: GM GLOBAL TECHNOLOGY OPERATIONS LLC, Detroit, MI (US)

(72) Inventors: Michael Slutsky, Kfar Saba (IL); Albert Shalumov, Petah Tikva (IL)

(73) Assignee: GM GLOBAL TECHNOLOGY OPERATIONS LLC, Detroit, MI (US)

(21) Appl. No.: 17/189,917

(22) Filed: Mar. 2, 2021

(51) Int. Cl. G06K 9/00; G06T 7/70; G06T 7/50

(52) U.S. Cl. CPC G06K 9/00791; G06T 7/70; G06T 7/50; G06T 2207/20084; G06T 2207/20081

(57) ABSTRACT

Systems and methods for generating a virtual view of a scene captured by a physical camera are described. The physical camera captures an input image with multiple pixels. A desired pose of a virtual camera for showing the virtual view is set. The actual pose of the physical camera is determined, and an epipolar geometry between the actual pose of the physical camera and the desired pose of the virtual camera is defined. The input image and depth data of the pixels of the input image are resampled in epipolar coordinates. A controller performs disparity estimation of the pixels of the input image and a deep neural network, DNN, corrects disparity artifacts in the output image for the desired pose of the virtual camera. The complexity of correcting disparity artifacts in the output image by a DNN is reduced by using epipolar geometry.

### TECHNICAL FIELD

The technical field generally relates to generating a virtual view based on image data captured by one or more physical cameras. Particularly, the description relates to correcting disparity artifacts in images that are created for a predetermined viewpoint of a virtual camera based on the images captured by the physical camera(s). More particularly, the description relates to systems and methods for generating a virtual view of a scene captured by a physical camera.

Modern vehicles are typically equipped with one or more optical cameras that are configured to provide image data to an occupant of the vehicle. For example, the image data show a predetermined perspective of the vehicle's surroundings.

Under certain conditions, it might be desirable to change the perspective onto the image data provided by an optical camera. For such a purpose, so-called virtual cameras are used, and the image data captured by one or more physical cameras are modified to show the captured scenery from another desired perspective; the modified image data may be referred to as virtual scene or output image. The desired perspective onto the virtual scene may be changed in accordance with an occupant's wish. The virtual scene may be generated based on multiple images that are captured from different perspectives. However, generating an output image for a virtual camera that is located at a desired viewpoint or merging image data from image sources that are located at different positions might cause undesired artifacts in the output image of the virtual camera. Such undesired artifacts may particularly result from depth uncertainties.

Accordingly, it is desirable to provide systems and methods for generating a virtual view of a scene captured by a physical camera with improved quality of the virtual scene, preserving the three-dimensional structure of the captured scene, and enabling to change the perspective from which the virtual scene is viewed.

Furthermore, other desirable features and characteristics of the present invention will become apparent from the subsequent detailed description and the appended claims, taken in conjunction with the accompanying drawings and the foregoing technical field and background.

### SUMMARY

A method for generating a virtual view of a scene captured by a physical camera is provided. In one embodiment, the method includes the steps: capturing, by the physical camera, an input image with multiple pixels; determining, by a controller, a desired pose of a virtual camera for showing an output image of the virtual view; determining, by the controller, an actual pose of the physical camera; defining, by the controller, an epipolar geometry between the actual pose of the physical camera and the desired pose of the virtual camera; resampling, by the controller, the input image and depth data of the multiple pixels of the input image in epipolar coordinates of the epipolar geometry; performing, by the controller, disparity estimation of the multiple pixels of the input image by re-projecting depth data of the multiple pixels of the input image onto the output image in the epipolar coordinates of the epipolar geometry; correcting, by a deep neural network, DNN, disparity artifacts in the output image for the desired pose of the virtual camera; and generating, by the controller, the output image based on the resampled input image and depth data of the multiple pixels of the input image, the disparity estimation by re-projecting depth data of the multiple pixels of the input image onto the output image, and the corrected disparity artifacts.

In one embodiment, the method further includes, after correcting, by the DNN, disparity artifacts in the output image for the viewpoint location of the virtual camera, synthesizing the output image in epipolar coordinates from the input image.

In one embodiment, the method further includes, after synthesizing the output image in epipolar coordinates from the input image, converting the output image to a selected virtual camera model.

In one embodiment, the selected virtual camera model defines a mode of presentation of the output image. For example, the mode of presentation is one of a perspective view, a cylindrical view, and a fisheye view. However, these exemplary modes of presentation are not to be understood as limiting the invention, and other modes of presentation may be used as deemed appropriate for a certain virtual camera perspective or user preference.

In one embodiment, the method further includes defining multiple desired poses of the virtual camera for showing the output image, wherein the correcting, by the DNN, disparity artifacts in the output image is performed for two or more of the multiple desired poses of the virtual camera. Preferably, the disparity artifacts are corrected for all desired poses of the virtual camera, so that a use can select one of the defined multiple poses and the output image is displayed almost instantaneously on a display that is located in the vehicle 10.

In one embodiment, the input image is a still image.

In one embodiment, the input image is a moving image.

In one embodiment, the method further includes: capturing, by multiple physical cameras, a respective input image, each of which comprises multiple pixels; defining, by the controller, an epipolar geometry between the actual pose of each physical camera and the desired pose of the virtual camera; resampling, by the controller, each input image and depth data of the multiple pixels of the input image in epipolar coordinates of the epipolar geometry; performing, by the controller, disparity estimation of the multiple pixels of each input image by re-projecting depth data of the multiple pixels of each input image onto the output image in the epipolar coordinates of the epipolar geometry; and correcting, by the DNN, disparity artifacts in the output image for the desired pose of the virtual camera based on the input images of the multiple physical cameras. In this embodiment, multiple input images are used to create a synthesized output image.

In one embodiment, the DNN is a residual learning neural network.

In one embodiment, the method further includes displaying the generated output image on a display.

A vehicle is provided that is configured to generate a virtual view of a scene. The vehicle includes a physical camera, configured to capture an input image with multiple pixels, and a controller. The controller is configured to: determine a desired pose of a virtual camera for showing an output image of the virtual view; determine an actual pose of the physical camera; define an epipolar geometry between the actual pose of the physical camera and the desired pose of the virtual camera; resample the input image and depth data of the multiple pixels of the input image in epipolar coordinates of the epipolar geometry; perform disparity estimation of the multiple pixels of the input image by re-projecting depth data of the multiple pixels of the input image onto the output image in the epipolar coordinates of the epipolar geometry; correct, by a deep neural network, DNN, that is implemented by the controller, disparity artifacts in the output image for the desired pose of the virtual camera; and generate the output image based on the resampled input image and depth data of the multiple pixels of the input image, the disparity estimation by re-projecting depth data of the multiple pixels of the input image onto the output image, and the corrected disparity artifacts.

In one embodiment, the controller is configured to synthesize the output image in epipolar coordinates from the input image after correcting, by the DNN that is implemented by the controller, disparity artifacts in the output image for the viewpoint location of the virtual camera.

In one embodiment, the controller is configured to convert the output image to a selected virtual camera model after synthesizing the output image in epipolar coordinates from the input image.

In one embodiment, the controller is configured to define a mode of presentation of the output image for the selected virtual camera model.

In one embodiment, the controller is configured to define multiple desired poses of the virtual camera for showing the output image; the controller is further configured to perform the correcting, by the DNN that is implemented by the controller, disparity artifacts in the output image for two or more of the multiple desired poses of the virtual camera.

In one embodiment, the physical camera is configured to capture a still image as the input image.

In one embodiment, the physical camera is configured to capture a moving image as the input image.

In one embodiment, the vehicle includes multiple physical cameras, each of which is configured to capture a respective input image, each of which comprises multiple pixels; wherein the controller is configured to define an epipolar geometry between the actual pose of each physical camera and the desired pose of the virtual camera; resample each input image and depth data of the multiple pixels of the input image in epipolar coordinates of the epipolar geometry; perform disparity estimation of the multiple pixels of each input image by re-projecting depth data of the multiple pixels of each input image onto the output image in the epipolar coordinates of the epipolar geometry; and correct, by the DNN that is implemented by the controller, disparity artifacts in the output image for the desired pose of the virtual camera based on the input images of the multiple physical cameras.

In one embodiment, the controller is configured to implement a residual learning neural network as the DNN.

In one embodiment, the vehicle further includes a display that is configured to display the output image to a user.

### BRIEF DESCRIPTION OF THE DRAWINGS

The exemplary embodiments will hereinafter be described in conjunction with the following drawing figures, wherein like numerals denote like elements, and wherein:

FIG. 1 is a schematic illustration of a vehicle with a controller implementing functions for generating a virtual view in accordance with an embodiment;

FIG. 2 is a schematic illustration of the principles of epipolar geometry with reference to two cameras;

FIG. 3 is a schematic illustration of a vehicle with different predetermined virtual camera poses in accordance with an embodiment;

FIG. 4 is a schematic illustration of a method for generating a virtual view in accordance with an embodiment;

FIG. 5 is a schematic illustration of a training process for disparity correction by a residual deep neural network.

### DETAILED DESCRIPTION

The following detailed description is merely exemplary in nature and is not intended to limit the application and uses. Furthermore, there is no intention to be bound by any expressed or implied theory presented in the preceding technical field, background, brief summary, or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

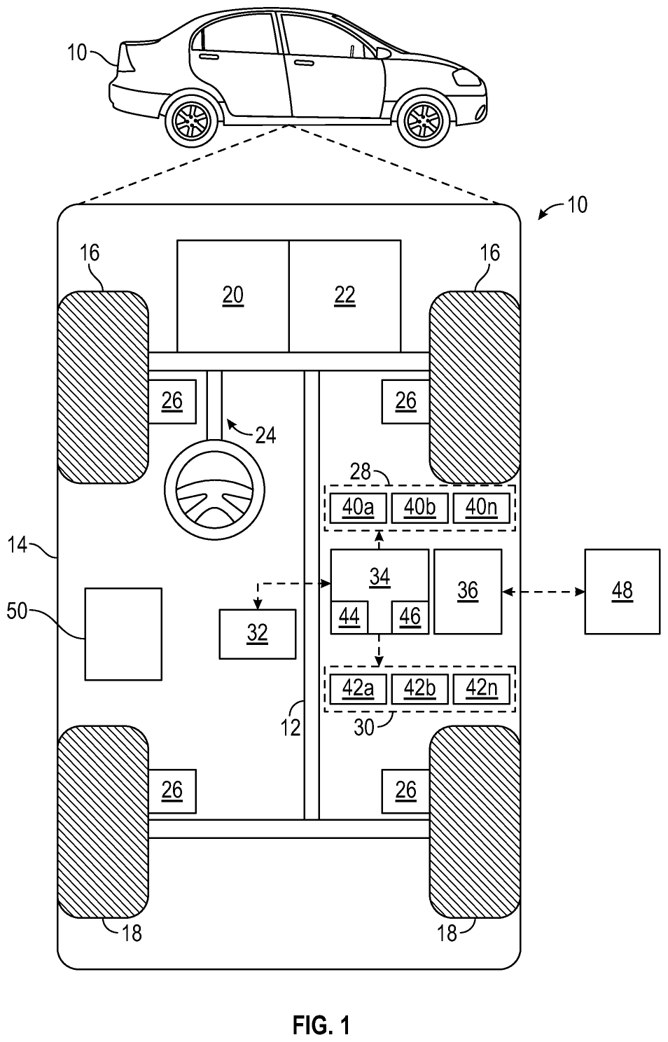

With reference to FIG. 1, a vehicle 10 is shown in accordance with various embodiments. The vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16 and 18 are each rotationally coupled to the chassis 12 near a respective corner of the body 14.

In various embodiments, the vehicle 10 is an autonomous vehicle. The autonomous vehicle is, for example, a vehicle that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), marine vessels, aircraft, etc., can also be used. In an exemplary embodiment, the autonomous vehicle is an automation system of Level Two or higher. A Level Two automation system indicates “partial automation”. However, in other embodiments, the autonomous vehicle may be a so-called Level Three, Level Four or Level Five automation system. A Level Three automation system indicates conditional automation. A Level Four system indicates “high automation”, referring to the driving mode-specific performance by an automated driving system of all aspects of the dynamic driving task, even when a human driver does not respond appropriately to a request to intervene. A Level Five system indicates “full automation”, referring to the full-time performance by an automated driving system of all aspects of the dynamic driving task under all roadway and environmental conditions that can be managed by a human driver.

However, it is to be understood that the vehicle 10 may also be a conventional vehicle without any autonomous driving functions. The vehicle 10 may implement the functions and methods for generating a virtual view and using epipolar reprojection for virtual view perspective change as described in this document for assisting a driver of the vehicle 10.

As shown, the vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16 an 18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16 and 18. The brake system 26 may, in various embodiments, include friction brakes, brake by wire, a regenerative braking system such as an electric machine, and/or other appropriate braking systems. The steering system 24 influences a position of the of the vehicle wheels 16 and 18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the vehicle 10. The sensing devices 40a-40n can include, but are not limited to, radars, lidars, global positioning systems, optical cameras, thermal cameras, ultrasonic sensors, and/or other sensors. The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc. (not numbered).

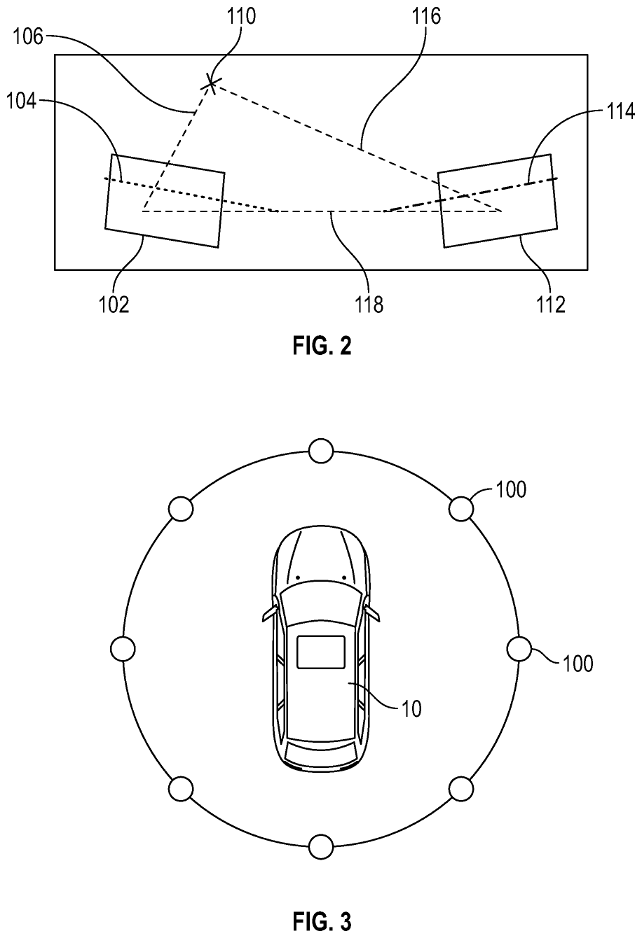

The communication system 36 is configured to wirelessly communicate information to and from other entities 48, such as but not limited to, other vehicles (“V2V” communication) infrastructure (“V2I” communication), remote systems, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in automatically controlling functions of the vehicle 10. In various embodiments, the data storage device 32 stores defined maps of the navigable environment. In various embodiments, the defined maps may be predefined by and obtained from a remote system (described in further detail with regard to FIG. 2). For example, the defined maps may be assembled by the remote system and communicated to the vehicle 10 (wirelessly and/or in a wired manner) and stored in the data storage device 32. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling and executing functions of the vehicle 10.

The instructions may include one or more separate programs, each of which comprises an ordered listing of executable instructions for implementing logical functions. The instructions, when executed by the processor 34, receive and process signals from the sensor system 28, perform logic, calculations, methods and/or algorithms for automatically controlling the components of the vehicle 10, and generate control signals to the actuator system 30 to automatically control the components of the vehicle 10 based on the logic, calculations, methods, and/or algorithms. Although only one controller 34 is shown in FIG. 1, embodiments of the vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

Generally, in accordance with an embodiment, the vehicle 10 includes a controller 34 that implements a method for generating a virtual view of a scene captured by a physical camera. One of the sensing devices 40a to 40n is an optical camera. In one embodiment, another one of these sensing devices 40a to 40n is a physical depth sensor (like lidar, radar, ultrasonic sensor, or the like) that is spatially separated from the physical camera. Alternatively, the depth sensor may be co-located with the physical camera and may implement depth-from-mono techniques that obtain depth information from images.

The vehicle 10 is designed to execute a method for generating a virtual view of a scene captured by a physical camera 40a with a co-located or spatially separated depth sensor 40b.

In one embodiment, the method includes the steps capturing, by the physical camera, an input image with multiple pixels; determining, by a controller, a desired pose of a virtual camera for showing an output image of the virtual view; determining, by the controller, an actual pose of the physical camera; defining, by the controller, an epipolar geometry between the actual pose of the physical camera and the desired pose of the virtual camera; resampling, by the controller, the input image and depth data of the multiple pixels of the input image in epipolar coordinates of the epipolar geometry; performing, by the controller, disparity estimation of the multiple pixels of the input image by re-projecting depth data of the multiple pixels of the input image onto the output image in the epipolar coordinates of the epipolar geometry; correcting, by a deep neural network, DNN, disparity artifacts in the output image for the desired pose of the virtual camera; and generating, by the controller, the output image based on the resampled input image and depth data of the multiple pixels of the input image, the disparity estimation by re-projecting depth data of the multiple pixels of the input image onto the output image, and the corrected disparity artifacts. The vehicle 10 includes a display 50 for displaying the output image to a user or occupant of the vehicle 10.

The input image is captured by a physical camera 40a, e.g., an optical camera that is configured to capture color pictures of the environment. The physical camera 40a is arranged at the vehicle 10 so that it can cover a certain field of view of the vehicle's surroundings. Depth information may be assigned to the pixels of the input image in order to obtain or estimate the distance between the physical camera 40a and an object that is represented by the pixels of the input image. Depth information may be assigned to each pixel of the input image, by a dense or sparse depth sensor or by a module that is configured to determine the depth based on image information.

The desired pose of the virtual camera may include information about the view location and view direction of the virtual camera. In addition thereto, intrinsic calibration parameters of the virtual camera may be given to determine the field of view, the resolution, and optionally or additionally other parameters of the virtual camera. The desired pose may be a pose defined by a user of a vehicle 10. Thus, the user or occupant of the vehicle 10 may choose a pose of the virtual camera for displaying the vehicle's surroundings.

The desired pose of the virtual camera may include the view location and view direction with respect to a reference point or reference frame, e.g., the view location and view direction of the virtual camera with respect to a vehicle. The desired pose is a virtual position where a user wants a virtual camera to be located, including the direction into which the virtual camera points. The desired pose may be changed by a user of a vehicle to generate a virtual view of the vehicle and its environment from different view locations and for different view directions.

The actual pose of the physical camera is determined to have information about the perspective from which the input image is captured. An input image is captured with multiple pixels. The input image and depth data of the multiple pixels of the input image are resampled in epipolar coordinates of the epipolar geometry. For the resampling, all or some pixels of the input image are used.

The pose of the physical camera may be measured or estimated by specific pose measurement arrangements or pose estimation modules. The controller 34 as described herein obtains the pose of the physical camera from these pose measurement arrangements or pose estimation modules, i.e., determines the pose by reading or obtaining the specific pose value, and uses the determined pose value for the steps of the method described herein.

The depth sensor 40b may be a physical depth sensor or a module (may be called virtual depth sensor) that assigns depth information to a pixel or an object of the input image based on image information. Examples for a physical depth sensor are ultrasonic sensors, radar sensors, lidar sensors, or the like. These sensors are configured to determine a distance to a physical object. The distance information determined by the physical depth sensors are then assigned to the pixels of the input image. A so-called virtual depth sensor determines or estimates depth information based on the image information. To generate an appropriate output image for the pose of the virtual camera, it might be sufficient if the depth information provided by the virtual depth sensor are consistent. It is not necessarily required that the depth information is absolutely accurate.

The disparity referred to herein relates to the difference between a pixel's position on cameras which are located at different positions. The disparity is connected to the distance between an object and the camera at different positions. The greater this distance is, the smaller is the disparity of an object or the pixels representing that object. In epipolar geometry, the disparity is the difference in pixel positions for two cameras along the respective epipolar lines.

In one embodiment, the method described herein separates the processing chain into a parametrizable stage and a non-parametrizable stage. The parametrizable stage performs initial disparity estimation of the pixels of the input image by re-projecting depth data of the multiple pixels of the input image onto the output image in the epipolar coordinates of the defined epipolar geometry. The non-parametrizable stage corrects disparity artifacts in the output image for a viewpoint location of the virtual camera.

The DNN may be implemented by the controller 34 of the vehicle 10. The DNN may be trained for one or more certain virtual camera poses from which a user or occupant of the vehicle 10 may select one. If it is intended to offer other virtual camera poses to the user to select from, the DNN may require to be trained for the other virtual camera poses.

FIG. 2 exemplarily shows the principles of the epipolar geometry with reference to a first camera 102 with the camera center C1 and a second camera 112 with the camera center C2. The first camera 102 may be a physical camera and the second camera 112 may be a virtual camera. A first epipolar line 104 is defined in the first camera 102. A ray 106 defines the position of the pixel P (indicated with 110) on the epipolar line 104. The position of the same pixel P 110 is also defined on epipolar line 114 by ray 116 that extends from the camera center C2 of the second camera 112 to the pixel P. Reference sign 118 is a vector between the two camera centers C1 and C2. Given the vector 118 and the known position of pixel P on the epipolar line 104 as well as the distance between the camera center C1 and pixel P, the position of pixel P on the epipolar line 114 can be determined. With this underlying principle, the scene captured by the first camera 102 can be used to calculate a scene as it would be observed with the second camera 112. The virtual position of the second camera 112 can be varied. Consequently, the position of the pixels on the epipolar line 114 also varies when the position of the second camera 112 is varied. In various embodiments described herein, a virtual view perspective change is enabled. This virtual view perspective change may be advantageously used for generating surround views and for trailering applications. Using the epipolar geometry for generating the virtual view considers the three-dimensional nature of the environment of a vehicle, particularly by considering the depth of a pixel P (distance between pixel P and camera center C1 of the first camera 102) when generating the virtual view of the second camera 112.

FIG. 3 schematically shows a vehicle 10 with eight distinct virtual camera poses 100. The virtual camera may be located at either of the eight predetermined virtual camera poses 100 by user selection to then generate an output image as viewed by a camera on the selected position. The DNN is trained to correct disparity artifacts in the output image for each of these predetermined virtual camera poses 100. However, if other virtual camera poses 100 are to be used, the DNN requires to be trained for the other virtual camera poses. The same applies when the pose of the physical camera(s) changes.

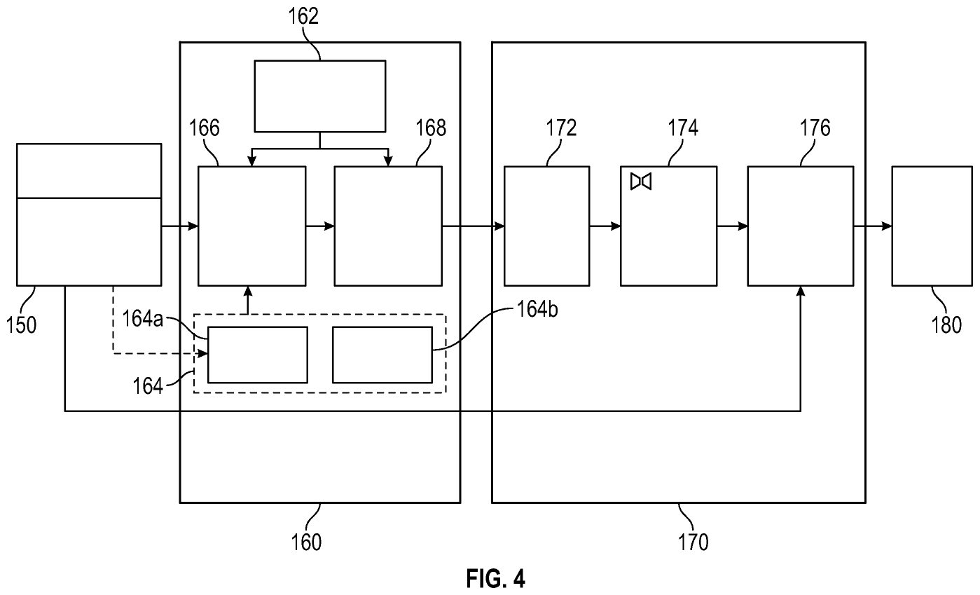

FIG. 4 schematically shows a method for generating a virtual view of a scene captured by a physical camera in accordance with an embodiment. At 150, surround images or input images of the physical camera are captured and calibration and alignment data of the physical cameras are acquired. Preferably, intrinsic calibration parameters of the input camera pose data may be acquired. The intrinsic parameters of an input camera, e.g., a perspective camera, typically include focal distance, principal point, distortion model, etc. The intrinsic calibration parameters of the input camera and of the desired viewpoint data of the virtual camera may be used to define the epipolar geometry. Block 160 includes the steps that are carried out during the parametrized stage and block 170 includes the steps that are carried out during the non-parametrizable stage, as introduced above. At 162, desired viewpoint data are acquired, i.e., a desired pose of a virtual camera for showing an output image of the virtual view is determined, for example by receiving a control command or an input value from a user of the vehicle 10. At 164, depth data of the input image captured at 150 is determined, e.g., by using depth-from-mono techniques indicated by 164a or by making use of dedicated depth sensors indicated by 164b. At 166, the input image captured at 150, the depth data determined at 164, and the desired viewpoint data acquired at 162 are used to resample these in epipolar coordinates of an epipolar geometry. At 168, an initial disparity estimation is carried out based on the data resampled at 166 and the desired viewpoint data acquired at 162. Now, the method continues with generating a disparity map at 172 in block 170, correction of disparity artifacts at block 174 by the DNN implemented by the controller 34 of the vehicle 10, and generating the output image at 176. At 180, the output image is provided to the display for being displayed to the user of the vehicle.

For capturing depth data at 164, depth-from-mono techniques may be used that derive depth information from the input image, shown at 164a. Alternatively, distinct physical depth sensors may be used, shown at 164b. The physical depth sensor may be a sparse depth sensor or a dense depth sensor. A sparse depth sensor provides depth information for some pixels and regions of the input image, but not for all pixels. A sparse depth sensor does not provide a continuous depth map. A dense depth sensor provides depth information for every pixel of the input image.

With further reference to FIG. 4, in one embodiment, the method for disparity-based image rendering includes the following steps: establishing epipolar geometry based on known intrinsic and extrinsic calibration parameters for two cameras, and then estimate disparity for each point in the common field-of-view (FOV) of the two cameras. From disparity, depth of a pixel or an object can be estimated, which is how stereo-based depth estimation works. With a known depth of a plurality or all pixels in an image, the three dimensional position of a pixel can be reprojected onto a virtual camera at a desired location. When the epipolar geometry is known, knowledge of a full three dimensional position of the pixel source to generate virtual camera image is not needed. It is sufficient to estimate the disparity of the pixel along the corresponding epipolar line. Therefore, the DNN-based image rendering can be parametrized by utilizing the knowledge of epipolar geometry. Typically, the three-dimensional position of a pixel is almost never known with sufficient precision; even if a depth sensor is available, its output is usually sparse, noisy, and/or spatially separated from the viewpoint. For these reasons, disparity estimated during the parametrized stage, even when using epipolar reprojection, typically contain multiple errors. In the non-parametrized stage, these errors are corrected by a DNN in a manner independent on viewpoint location by residual learning. Training ground truth (GT) is built by acquiring regular and depth imagery from various viewpoints covering the FOV of interest. Dense disparity GT is generated by projection of depth maps onto the input image of the physical camera. Finally, even for a fixed viewpoint, it is preferred to work in epipolar coordinates, since for each output pixel, the DNN needs to learn only one, not two (or more) numbers.

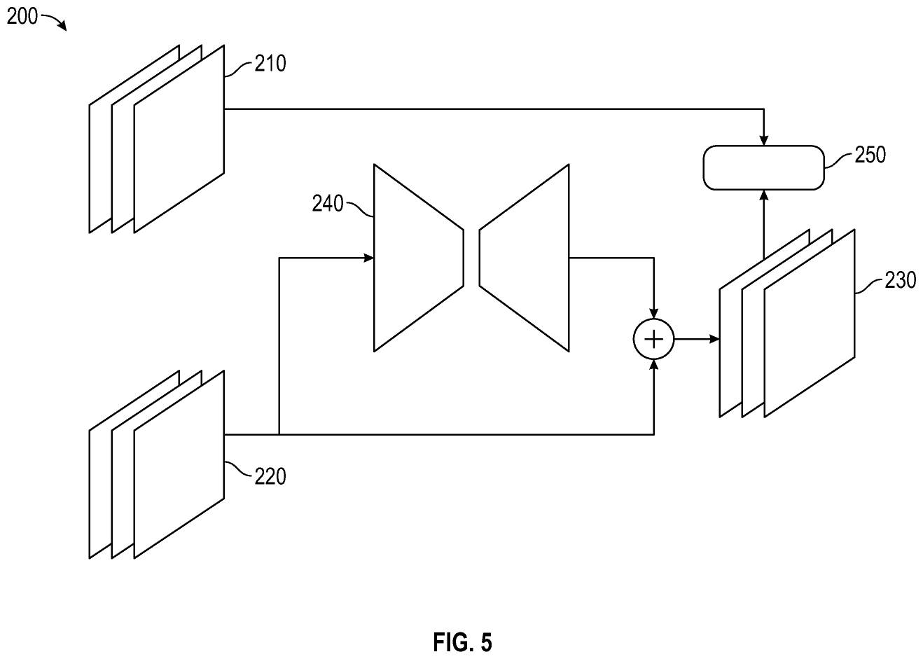

FIG. 5 schematically shows how a residual deep neural network is trained for being used in the method described herein. The method for training the residual DNN is generally indicated by 200. At 210, a ground-truth (GT) disparity is generated for each output pixel by projecting 3D coordinates of corresponding pixels in reference images onto physical cameras and calculating the distance along the epipolar line. Thus, ground-truth disparity arrays are built at 210. At 220, intermediate disparity arrays are fed into a deep neural network, DNN, 240 and the DNN output is added to the intermediate disparity arrays fed into the DNN at 220 to produce corrected disparities at 230. The DNN shown at 240 is trained to estimate residual disparities or disparity errors, to that the corrected disparities are as close as possible to the corresponding GT disparities shown at 210. For this purpose, DNN architectures such as ResNet or Residual U-Net can be used. DNN training is performed by minimizing the loss function shown at 250, which is taken to be one of standard losses, such as L1-norm, L2-norm or MSE of disparity difference.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for generating a virtual view of a scene captured by a physical camera, the method comprising the steps:
capturing, by the physical camera, an input image with multiple pixels;
determining, by a controller, a desired pose of a virtual camera for showing an output image of the virtual view;
determining, by the controller, an actual pose of the physical camera;
defining, by the controller, an epipolar geometry between the actual pose of the physical camera and the desired pose of the virtual camera;
resampling, by the controller, the input image and depth data of the multiple pixels of the input image in epipolar coordinates of the epipolar geometry;
performing, by the controller, disparity estimation of the multiple pixels of the input image by re-projecting depth data of the multiple pixels of the input image onto the output image in the epipolar coordinates of the epipolar geometry;
correcting, by a deep neural network, DNN, disparity artifacts in the output image for the desired pose of the virtual camera; and
generating, by the controller, the output image based on the resampled input image and depth data of the multiple pixels of the input image, the disparity estimation by re-projecting depth data of the multiple pixels of the input image onto the output image, and the corrected disparity artifacts.

2. The method of claim 1, further comprising:
after correcting, by the DNN, disparity artifacts in the output image for the viewpoint location of the virtual camera:
synthesizing the output image in epipolar coordinates from the input image.

3. The method of claim 2, further comprising:
after synthesizing the output image in epipolar coordinates from the input image:
converting the output image to a selected virtual camera model.

4. The method of claim 3,
wherein the selected virtual camera model defines a mode of presentation of the output image.

5. The method of claim 1, further comprising
defining multiple desired poses of the virtual camera for showing the output image;
wherein the correcting, by the DNN, disparity artifacts in the output image is performed for two or more of the multiple desired poses of the virtual camera.

6. The method of claim 1,
wherein the input image is a still image.

7. The method of claim 1,
wherein the input image is a moving image.

8. The method of claim 1, further comprising:
capturing, by multiple physical cameras, a respective input image, each of which comprises multiple pixels;
defining, by the controller, an epipolar geometry between the actual pose of each physical camera and the desired pose of the virtual camera;
resampling, by the controller, each input image and depth data of the multiple pixels of the input image in epipolar coordinates of the epipolar geometry;
performing, by the controller, disparity estimation of the multiple pixels of each input image by re-projecting depth data of the multiple pixels of each input image onto the output image in the epipolar coordinates of the epipolar geometry; and
correcting, by the DNN, disparity artifacts in the output image for the desired pose of the virtual camera based on the input images of the multiple physical cameras.

9. The method of claim 1,
wherein the DNN is a residual learning neural network.

10. The method of claim 1, further comprising:
displaying the generated output image on a display.

11. A vehicle that is configured to generate a virtual view of a scene, the vehicle comprising
a physical camera, configured to capture an input image with multiple pixels; and
a controller;
wherein the controller is configured to:
determine a desired pose of a virtual camera for showing an output image of the virtual view;
determine an actual pose of the physical camera;
define an epipolar geometry between the actual pose of the physical camera and the desired pose of the virtual camera;
resample the input image and depth data of the multiple pixels of the input image in epipolar coordinates of the epipolar geometry;
perform disparity estimation of the multiple pixels of the input image by re-projecting depth data of the multiple pixels of the input image onto the output image in the epipolar coordinates of the epipolar geometry;
correct, by a deep neural network, DNN, that is implemented by the controller, disparity artifacts in the output image for the desired pose of the virtual camera; and
generate the output image based on the resampled input image and depth data of the multiple pixels of the input image, the disparity estimation by re-projecting depth data of the multiple pixels of the input image onto the output image, and the corrected disparity artifacts.

12. The vehicle of claim 11,
wherein the controller is configured to synthesize the output image in epipolar coordinates from the input image after correcting, by the DNN that is implemented by the controller, disparity artifacts in the output image for the viewpoint location of the virtual camera.

13. The vehicle of claim 12,
wherein the controller is configured to convert the output image to a selected virtual camera model after synthesizing the output image in epipolar coordinates from the input image.

14. The vehicle of claim 13,
wherein the controller is configured to define a mode of presentation of the output image for the selected virtual camera model.

15. The vehicle of claim 11,
wherein the controller is configured to define multiple desired poses of the virtual camera for showing the output image;
wherein the controller is configured to perform the correcting, by the DNN that is implemented by the controller, disparity artifacts in the output image for two or more of the multiple desired poses of the virtual camera.

16. The vehicle of claim 11,
wherein the physical camera is configured to capture a still image as the input image.

17. The vehicle of claim 11,
wherein the physical camera is configured to capture a moving image as the input image.

18. The vehicle of claim 1, further comprising:
multiple physical cameras, each of which is configured to capture a respective input image, each of which comprises multiple pixels;
wherein the controller is configured to:
define an epipolar geometry between the actual pose of each physical camera and the desired pose of the virtual camera;
resample each input image and depth data of the multiple pixels of the input image in epipolar coordinates of the epipolar geometry;
perform disparity estimation of the multiple pixels of each input image by re-projecting depth data of the multiple pixels of each input image onto the output image in the epipolar coordinates of the epipolar geometry; and
correct, by the DNN that is implemented by the controller, disparity artifacts in the output image for the desired pose of the virtual camera based on the input images of the multiple physical cameras.

19. The vehicle of claim 11,
wherein the controller is configured to implement a residual learning neural network as the DNN.

20. The vehicle of claim 11, further comprising:
a display that is configured to display the output image to a user.
